(19) United States
(12) Patent Application Publication
(10) Pub. No.: US 2010/0212359 A1
(43) Pub. Date: Aug. 26, 2010

(54) SPINEL ISOPIPE FOR FUSION FORMING ALKALI CONTAINING GLASS SHEETS

(76) Inventors: Hilary Tony Godard, Lindley, NY (US); Mark E. Mack, Millport, NY (US)

Correspondence Address: CORNING INCORPORATED, SP-TI-3-1, CORNING, NY, 14831, US

(21) Appl. No.: 12/390,663

(22) Filed: Feb. 23, 2009

(51) Int. Cl. C03B 17/06; C04B 35/443

(52) U.S. Cl. 65/90; 65/374.13; 65/195

(57) ABSTRACT

A glass manufacturing system and method are described herein that use a forming apparatus (isopipe) made from or at least coated with a magnesium aluminate spinel material which is a chemically stable and compatible refractory material when used for forming an alkali-containing glass sheet.

### TECHNICAL FIELD

The present invention relates in general to the glass manufacturing field and, in particular, to a forming apparatus (also known as an “isopipe”) which is made from a chemically stable and compatible refractory material that can be used for forming an alkali-containing glass sheet.

### BACKGROUND

Down-draw processes, such as fusion or slot draw processes, have been and are currently being used to form high quality thin glass sheets that can be used in a variety of devices, such as flat panel displays, windows and cover plates for portable electronic communication and entertainment devices, and the like. The fusion process is a preferred technique for producing glass sheets used in flat panel displays because this process produces glass sheets with surfaces having superior flatness and smoothness when compared to glass sheets produced by other methods.

The fusion process makes use of a specially shaped refractory block, referred to as an isopipe (i.e., forming apparatus) over which molten glass flows down both sides and meets at the bottom to form a single glass sheet. One such isopipe made from a refractory material known as zircon has been used for many years to make display glass sheets. However, zircon does not appear to be the material of choice for making sheets of glass comprising alkali metals (referred to herein as “alkali-containing glass”). In particular, attempts to manufacture alkali-containing glass sheets using zircon isopipes have resulted in the formation of undesirable zirconia defects. The zirconia defects are formed when alkali metals in the alkali-containing glass causes the zircon on the isopipe surface to dissociate into silica glass and zirconia. The presence of this silica glass and zirconia makes the resulting glass sheet prone to having undesirable cords or knots.

### SUMMARY

In one aspect, the present invention provides a glass manufacturing system which has at least one vessel for providing an alkali-containing molten glass, and a forming apparatus for receiving the alkali-containing molten glass from one of the vessels and forming an alkali-containing glass sheet. At least an exposed portion of the forming apparatus that contacts the alkali-containing molten glass is made from magnesium aluminate spinel. The magnesium aluminate spinel forming apparatus does not react adversely with the alkali-containing molten glass when forming the alkali-containing glass sheet.

In another aspect, the present invention provides a method for manufacturing an alkali-containing glass sheet where the method includes the steps of: (a) melting alkali-containing batch materials to form an alkali-containing molten glass; and (b) delivering the alkali-containing molten glass to a forming apparatus and forming the alkali-containing glass sheet. At least an exposed portion of the forming apparatus that contacts the alkali-containing molten glass is made from magnesium aluminate spinel. The magnesium aluminate spinel forming apparatus does not react adversely with the alkali-containing molten glass when forming the alkali-containing glass sheet.

In still yet another aspect, the present invention provides a forming apparatus for forming an alkali-containing glass sheet. The forming apparatus includes a body having an inlet that receives alkali-containing molten glass, which flows into a trough formed in the body, then overflows two top surfaces of the trough, and runs down two sides of the body before fusing together where the two sides of the body come together to form the alkali-containing glass sheet. The inlet, the trough, the two top surfaces, and the two sides are made from magnesium aluminate spinel. The magnesium aluminate spinel of the forming apparatus does not react adversely with the alkali-containing molten glass when forming the alkali-containing glass sheet.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings, wherein:

FIGS. 1A-1C respectively show a SEM image and associated EDX spectra illustrating undesirable zirconia defects that where created when an alkali-containing glass flowed across an zircon refractory test strip;

FIG. 2 is a schematic view of an exemplary glass manufacturing system that uses a magnesium aluminate spinel isopipe to manufacture an alkali-containing glass sheet;

FIG. 3 is a perspective view illustrating in greater detail the magnesium aluminate spinel isopipe shown in FIG. 2;

FIGS. 4A-4F are various images and graphs which illustrate the results of a refractory strip gradient test performed with an alumina refractory test strip and an alkali-containing glass;

FIG. 5 is an image of a magnesium aluminate spinel (Frimax 7) refractory brick and an alkali-containing glass that underwent a refractory strip gradient test;

FIGS. 6A-6E are various images and graphs which illustrate the results of a refractory strip gradient test performed with a magnesium aluminate spinel (Frimax 7) refractory brick and an alkali-containing glass; and

FIG. 7 is the MgO—Al₂O₃ phase diagram.

### DETAILED DESCRIPTION

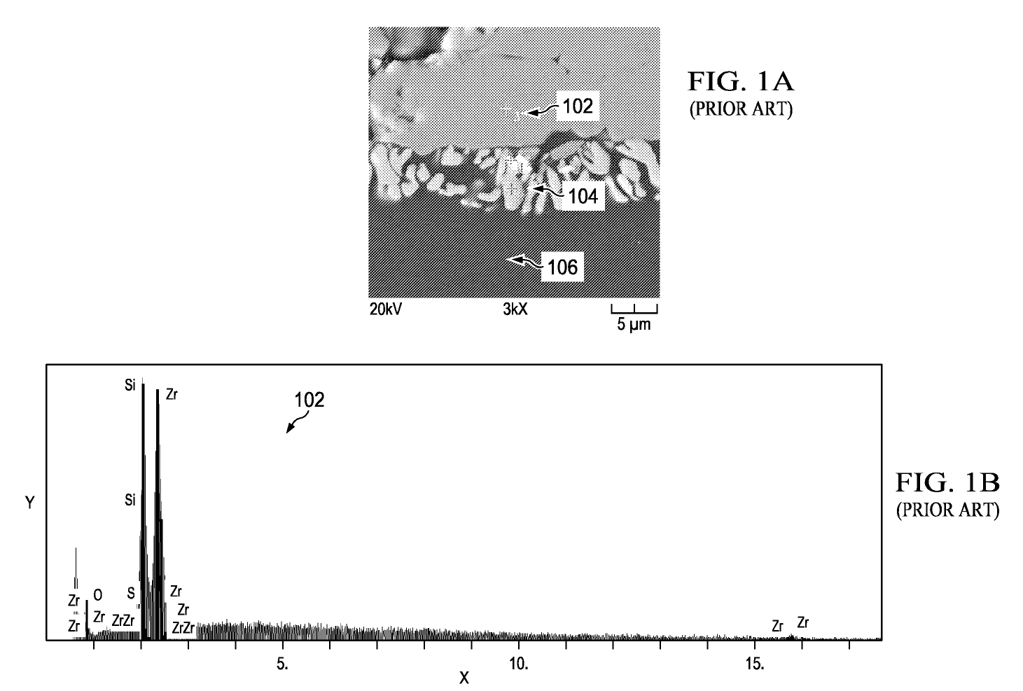

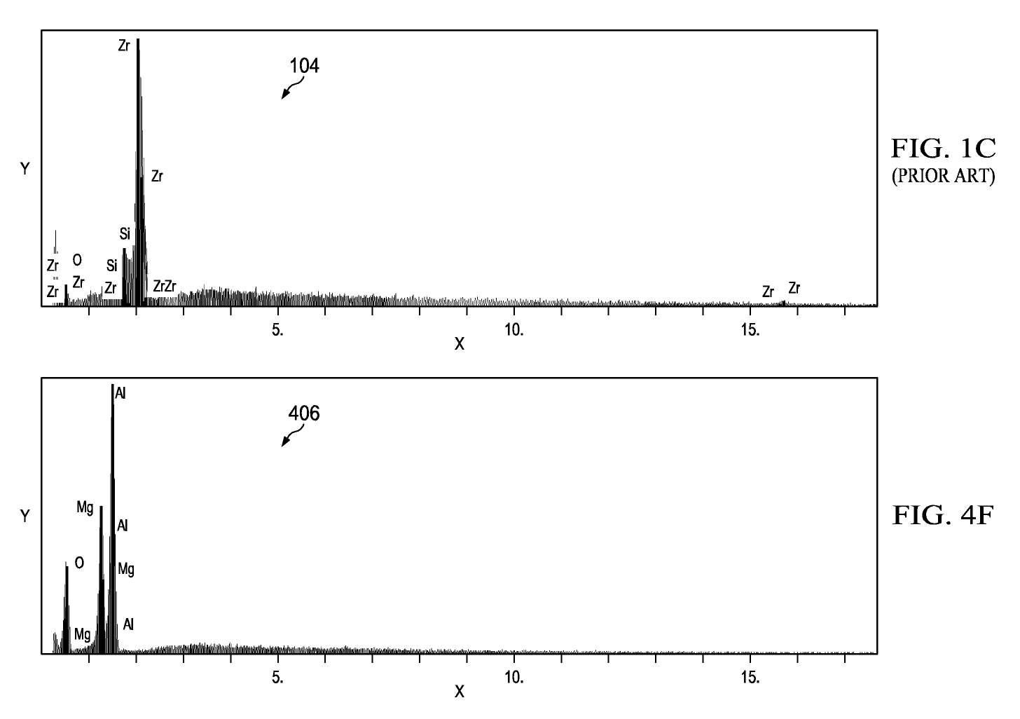

Prior to discussing the present solution, a description of two tests that were conducted to highlight the adverse interaction between zircon and alkali-containing glass is provided. First, a zircon refractory strip test was conducted using a sodium (Na) and potassium (K) alkali-containing glass (the composition of the glass is provided in Table #2) during which a scanning electron microscope (SEM) image and two energy dispersive X-ray (EDX) spectra based on the SEM images illustrated in FIGS. 1A-1C were obtained. In FIG. 1A, the SEM image illustrates the zircon strip 102 and the problematic dissociated zircon 104 (zirconia and silica) that was found along the refractory interface with the alkali-containing glass 106. The problematic dissociated zircon 104 includes zirconia 104 plus silica, where the silica is dissolved into the alkali-containing glass 106. In FIG. 1B, the EDX spectrum identifying the elemental composition of the zircon strip 102 is shown (note: the EDX spectrum graphs shown herein all have an x-axis that represents the energy of x-rays emitted by the various elements in the sample and a y-axis that represents the number of counts recorded or registered by a detector). In FIG. 1C, the EDX spectrum identifying the elemental composition of the zirconia 104 is shown. The dissociation of zircon 102 to zirconia 104 plus silica occurred at a relatively low temperature (1099° C.) during the test, due to the corrosive effects of sodium and potassium as they migrated into the zircon strip 102. This strip test was a modified version of a liquidus test based on the American Society for Testing and Materials (ASTM) C829-81 (2005) entitled “Standard Practices for Measurement of Liquidus Temperature of Glass by the Gradient Furnace Method.” The contents of this document are incorporated by reference herein.

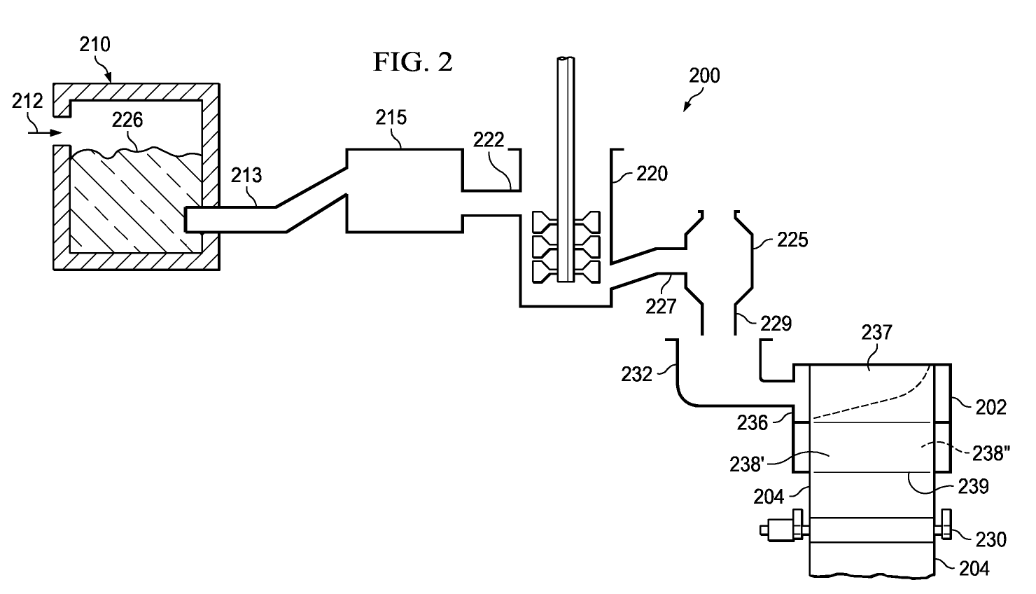

In addition, a second test was conducted where a sodium (Na) and lithium (Li) containing glass was run in contact with a zircon isopipe material. This test also demonstrated the problematic zirconia defects. The zirconia defects formed when the sodium and lithium in this specific type of alkali-containing glass caused the zircon on the isopipe material surface to dissociate into silica glass and zirconia. In fact, the zircon dissociation has been seen to occur as low as 1100° C. in the presence of sodium and/or lithium which is common with this specific type of alkali-containing glass. The exact mechanism by which alkali metals facilitate the zircon dissociation is unknown but, as can be seen from FIGS. 1A-1C, the phenomenon is well documented. It would be beneficial to find a way that can be used to produce alkali-containing glass in which there is no adverse interaction such as the dissociation described hereinabove between zircon and the alkali-containing glass. The present solution addresses this problem as discussed below with respect to FIGS. 2-6.

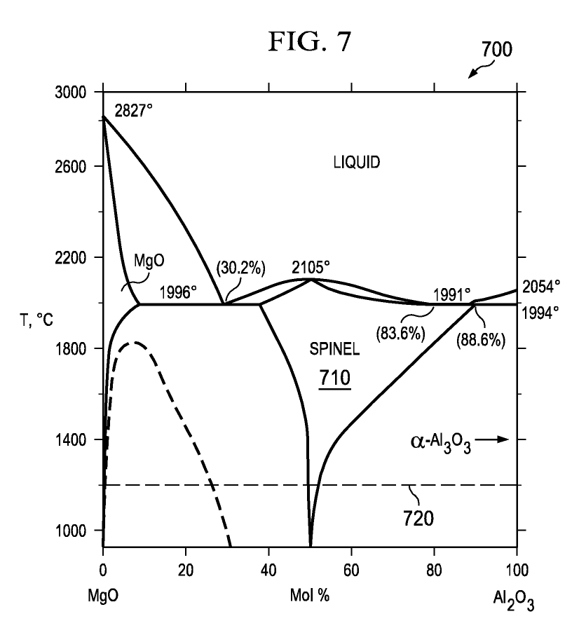

As used herein, the terms “magnesium aluminate spinel,” and “MgAl₂O₄” refer to the crystalline spinel phase that occurs in the binary magnesia-alumina (MgO—Al₂O₃) system. In the magnesium aluminate spinel crystal structure, oxygen ions form a face-centered cubic (fcc) lattice with alumina occupying one half of the octahedral interstitial sites and magnesium ions occupying one eighth of the tetrahedral sites. FIG. 7 is the magnesia-alumina phase diagram reported by B. Hallstedt (J. Am. Ceram. Soc. 75(6) pp. 1497-1507 (1992)), the contents of which are incorporated herein by reference in their entirety. Phase diagram 700 represents an assessment of previous phase studies in this system combined with computer optimization and thermodynamic modeling, based in part upon previous work reported by E. F. Osborn (J. Am. Ceram. Soc., 36(5) pp. 147-151 (1953)) and A. M. Alperet al. (J. Am. Ceram. Soc., 45(6) pp. 263-268 (1962)) the contents of which are also incorporated herein by reference in their entirety. The composition range of the magnesium aluminate spinel phase 710 is temperature dependent. Below about 1000° C., the magnesium aluminate spinel phase 710 has essentially a stoichiometric MgAl₂O₄ (i.e., (MgO)_{0.5}(Al₂O₃)_{0.5}) composition. With increasing temperature the composition range of magnesium aluminate spinel phase 710 broadens to include alumina (Al₂O₃)-rich compositions and, at higher temperature, magnesia (MgO)-rich compositions. Most isopipes operate at temperatures of up to about 1250° C. At this temperature (shown as isotherm 720 in FIG. 7), the magnesium aluminate spinel phase 710 includes compositions that are slightly enriched in alumina.

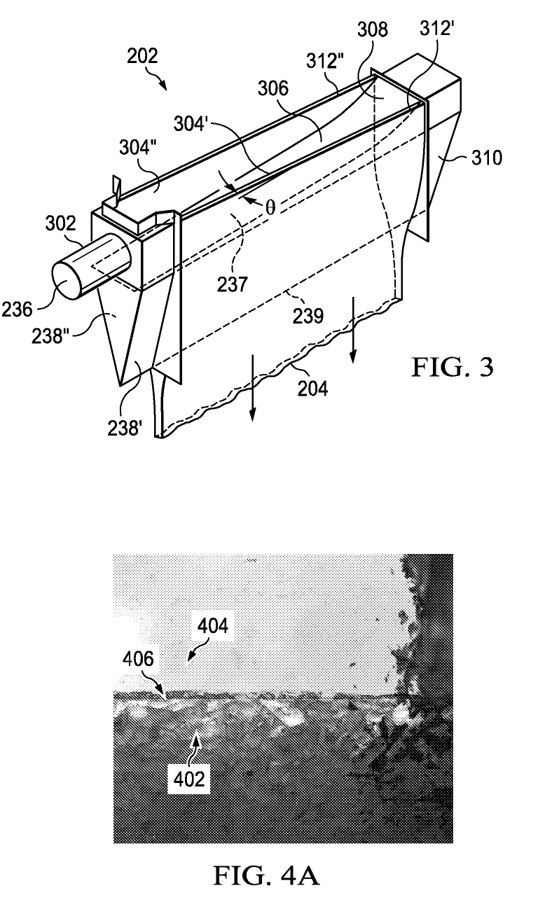

Referring to FIG. 2, a schematic view of an exemplary glass manufacturing system 200 which uses a magnesium aluminate spinel (MgAl₂O₄) isopipe 202 to manufacture an alkali-containing glass sheet 204 is shown. As shown in FIG. 2, the exemplary glass manufacturing system 200 includes a melting vessel 210, a fining vessel 215, a mixing vessel 220 (i.e., stir chamber 220), a delivery vessel 225 (i.e., bowl 225), the MgAl₂O₄ isopipe 202 (MgAl₂O₄ forming apparatus 202) and a pull roll assembly 230 (i.e., fusion draw machine 230). The melting vessel 210 is where alkali-containing glass batch materials are introduced, as shown by arrow 212, and melted to form alkali-containing molten glass 226. The fining vessel 215 (i.e., finer tube 215) has a high temperature processing area that receives the alkali-containing molten glass 226 (not shown at this point) via a refractory tube 213 from the melting vessel 210 and in which bubbles are removed from the alkali-containing molten glass 226. The fining vessel 215 is connected to the mixing vessel 220 (i.e., stir chamber 220) by a finer to stir chamber connecting tube 222. And, the mixing vessel 220 is connected to the delivery vessel 225 by a stir chamber to bowl connecting tube 227. The delivery vessel 225 delivers the alkali-containing molten glass 226 through a downcorner 229 to an inlet 232 and into the MgAl₂O₄ isopipe 202. The MgAl₂O₄ isopipe 202 includes an inlet 236 that receives the alkali-containing molten glass 226 which flows into a trough 237 and then overflows and runs down two sides 238′ and 238″ before fusing together at what is known as a root 239 (see FIG. 3). The root 239 is where the two sides 238′ and 238″ come together and where the two overflow walls of the alkali-containing molten glass 226 rejoin (i.e., re-fuse) before being drawn downward between two rolls in the pull roll assembly 230 to form the alkali-containing glass sheet 204 (alkali-containing glass substrate 204). A more detailed discussion about an exemplary configuration of the MgAl₂O₄ isopipe 202 is provided next with respect to FIG. 3.

Referring to FIG. 3, a perspective view of the exemplary MgAl₂O₄ isopipe 202 that does not react adversely with the alkali-containing glass 226 is shown. The MgAl₂O₄ isopipe 202 includes a feed pipe 302 that provides the alkali-containing molten glass 226 through the inlet 236 to the trough 237. The trough 237 is bounded by interior side-walls 304′ and 304″ that are shown to have a substantially perpendicular relationship, but could have any type of relationship to a bottom surface 306. In this example, the MgAl₂O₄ isopipe 202 has a bottom surface 306 which has a sharp decreasing height contour near the end 308 farthest from the inlet 236. If desired, the MgAl₂O₄ isopipe 202 can have a bottom surface 306, which has located thereon an embedded object (embedded plow) near the end 308 farthest from the inlet 236.

The exemplary MgAl₂O₄ isopipe 202 has a cuneiform/wedge shaped body 310 with the oppositely disposed converging side-walls 238′ and 238″. The trough 237 having the bottom surface 306, and possibly the embedded object (not shown), is longitudinally located on the upper surface of the wedge-shaped body 310. The bottom surface 306 and embedded object (if used) both have mathematically described patterns that become shallow at end 308, which is the end the farthest from the inlet 236. As shown, the height between the bottom surface 306 and the top surfaces 312′ and 312″ of the trough 237 decreases as one moves away from the inlet 236 towards the end 308. However, it should be appreciated that the height can vary in any manner between the bottom surface 306 and the top surfaces 312′ and 312″. It should also be appreciated that the cuneiform/wedge shaped body 310 may be pivotally adjusted by a device such as an adjustable roller, wedge, cam or other device (not shown) to provide a desired tilt angle shown as θ, which is the angular variation from the horizontal of the parallel top surfaces 312′ and 312″.

In operation, alkali-containing molten glass 226 enters the trough 237 through the feed pipe 302 and inlet 236. Then the alkali-containing molten glass 226 wells over the parallel top surfaces 312′ and 312″ of the trough 237, divides, and flows down each side of the oppositely disposed converging sidewalls 238′ and 238″ of the wedge-shaped body 310. At the bottom of the wedge portion, or root 239, the divided molten glass 226 rejoins to form the alkali-containing glass sheet 204, which has very flat and smooth surfaces. The high surface quality of the alkali-containing glass sheet 204 results from a free surface of alkali-containing molten glass 226 that divides and flows down the oppositely disposed converging side-walls 238′ and 238″ and forming the exterior surfaces of the alkali-containing glass sheet 204 without coming into contact with the outside of the MgAl₂O₄ isopipe 202. The MgAl₂O₄ isopipe 202 is desirable since it is made (or at least partially coated) with MgAl₂O₄, which does not react adversely with the alkali-containing molten glass 226 during fusion forming of the alkali-containing glass sheet 204. This is a marked improvement over the traditional zircon isopipe which, when it came into contact with alkali-containing molten glass, would result in the formation of undesirable zirconia defects that would adversely affect the quality of the alkali-containing glass sheet. A discussion about how this problem was solved by using a MgAl₂O₄ isopipe 202 (MgAl₂O₄ forming apparatus 202) is provided next with respect to several experiments.

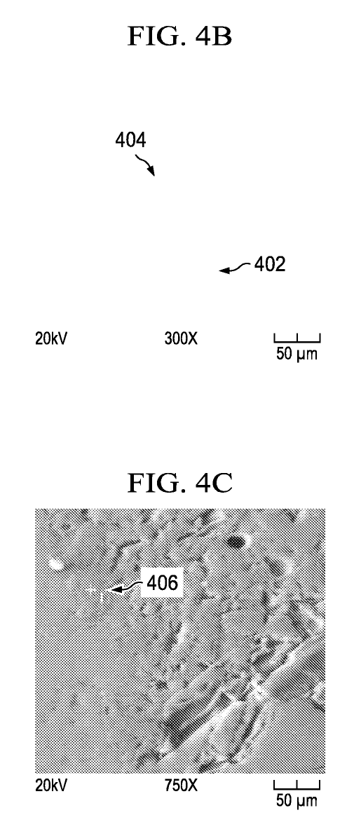

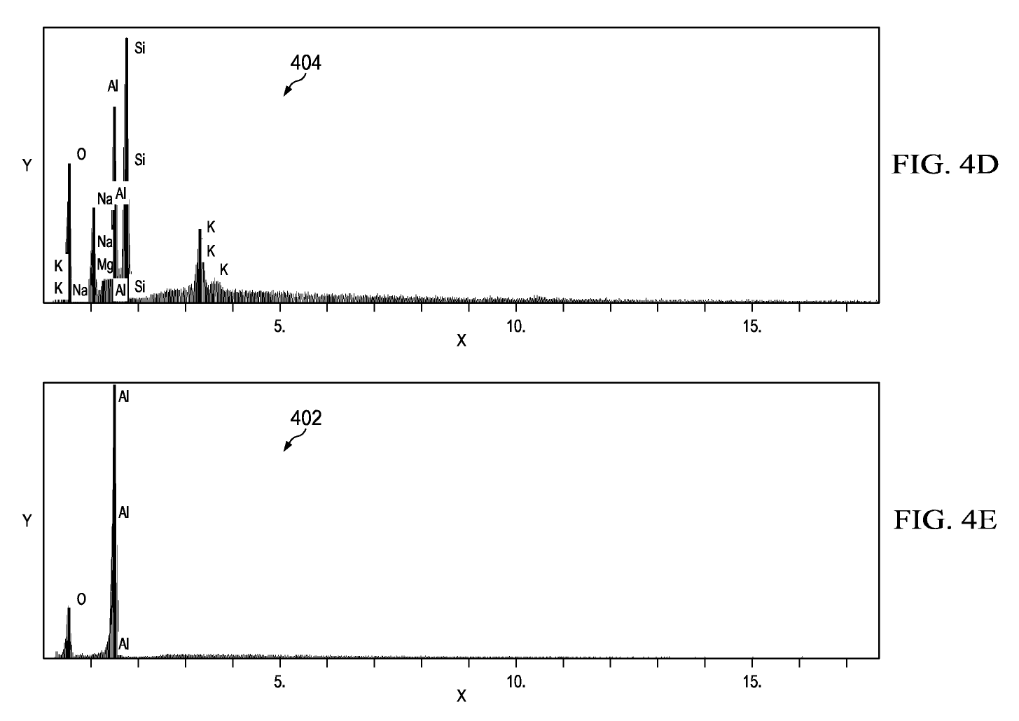

In an effort to solve the problem caused by using a traditional zircon isopipe to fusion form an alkali-containing glass sheet, a gradient test was conducted with an alternative material, namely a dense alumina refractory strip and an alkali-containing glass (see TABLE #1). The gradient test was conducted at a hot end temperature of 1250° C. to see if alumina would be a more compatible material than zircon based on its alteration properties with this alkali-containing glass. FIG. 4A is a Polarized Light Microscopy (PLM) image (20× objective) of the alumina refractory strip 402 and the alkali-containing glass 404 after the refractory strip gradient test. The PLM image indicates a refractory interface 406 that is located between the alumina refractory strip 402 and the alkali-containing glass 404. In this sample, the refractory interface 406 was identified as a secondary crystalline phase 406 or a devitrified phase 406. FIGS. 4B and 4C show an SEM image of the alumina refractory strip 402 and the alkali-containing glass 404 (300×)(FIG. 4B) and an SEM image of the devitrified phase 406 (750×)(FIG. 4C), respectively. FIGS. 4D and 4E show the EDX spectra identifying the elemental composition of the alkali-containing glass 404 and the alumina refractory strip 402 identified in the SEM image of FIG. 4B, respectively. FIG. 4F shows the EDX spectrum identifying the elemental composition of the devitrified phase 406 identified in the SEM image of FIG. 4C. The SEM/EDX analysis of the secondary devitrified phase 406 shown in the PLM image proved to be magnesium aluminate spinel 406 (see FIG. 4F). In fact, the test produced an extensive quantity of MgAl₂O₄ spinel 406 in the refractory interface 406 between the alumina refractory strip 402 and the alkali-containing glass 404. This test supported the idea that MgAl₂O₄ spinel 406 is a more stable crystalline phase when compared to alumina, with at least respect to this particular alkali-containing glass 404. This particular alkali-containing glass 404 has the composition, expressed in weight percent, listed in TABLE #1.

TABLE #1

| Material | Wt % |
|---|---|
| SiO₂ | 61 |
| Al₂O₃ | 16 |
| B₂O₃ | 0.7 |
| Na₂O | 13 |
| K₂O | 3.5 |
| MgO | 3.4 |
| CaO | 0.4 |
| ZrO₂ | 0.02 |
| As₂O₃ | 1.0 |
| Fe₂O₃ | 0.02 |

The composition in TABLE #1 is particularly desirable, since it is substantially free of Li, Ba, Sb, and As. A more detailed discussion about this type of alkali-containing glass can be found in the co-assigned U.S. Patent Application Publication No. 2008/0286548 A1, published Nov. 20, 2008 and entitled “Down-Drawable, Chemically Strengthened Glass for Cover Plate”. The contents of this document are hereby incorporated by reference herein. The glass described in U.S. Patent Application Publication No. 2008/0286548 A1 has the composition of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-18 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

Another test was conducted because alumina (aluminum oxide) isopipes have undesirable characteristics and, as such, are not preferred for forming alkali or non-alkali containing glass sheets. For instance, compared to zircon isopipes, alumina isopipes have high thermal coefficients of expansion, which cause thermal stresses in heat-up and make alumina isopipes prone to cracking. Plus, the alumina that dissolves into most glasses makes the glass more viscous. This in turn makes the glass prone to having cords or knots, which are linear or globular defects of alumina-rich glass that slowly dissolved within the base glass.

In the next experiment, the inventors tested a refractory brick made from MgAl₂O₄ spinel against two alkali-containing glasses. The tested MgAl₂O₄ spinel refractory brick is sold under the name Frimax 7 and is manufactured by DSF Refractories and Minerals Ltd, based in England. The first alkali-containing glass has a composition in TABLE #1 and the second alkali-containing glass has the composition listed in TABLE #2.

TABLE #2

| Material | wt % |
|---|---|
| SiO₂ | 62 |
| Al₂O₃ | 17 |
| Na₂O | 13 |
| K₂O | 3.4 |
| MgO | 3.6 |
| TiO₂ | 0.8 |
| As₂O₃ | 0.9 |

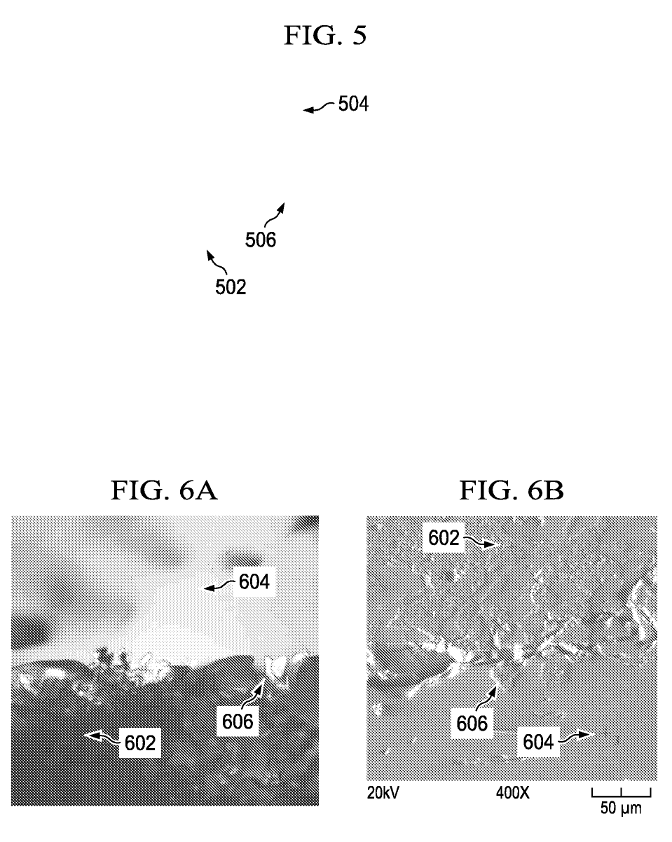

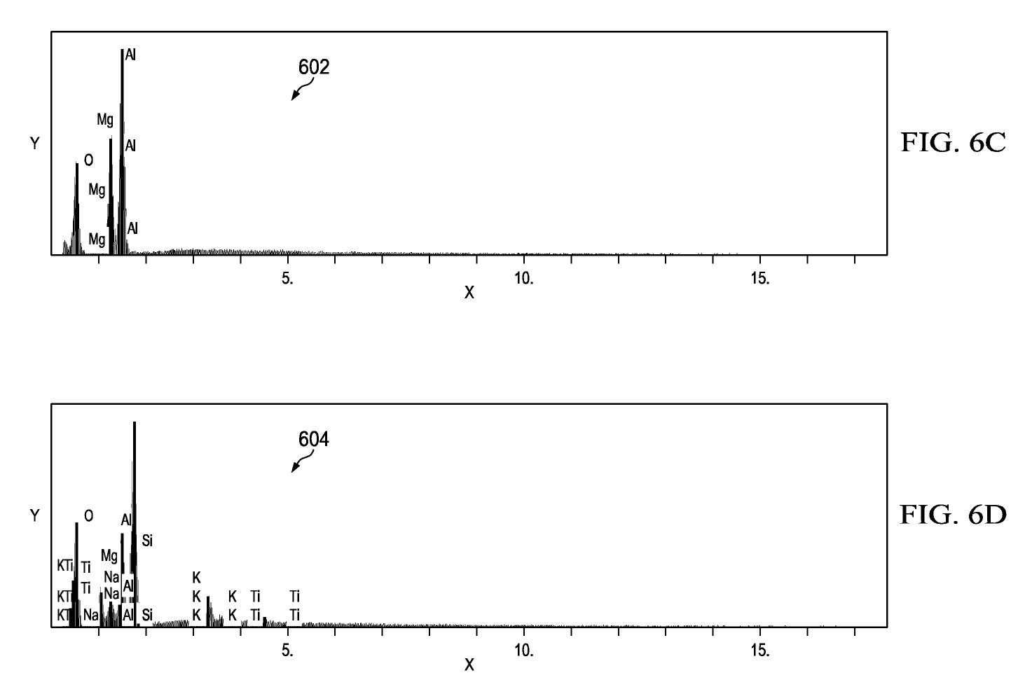

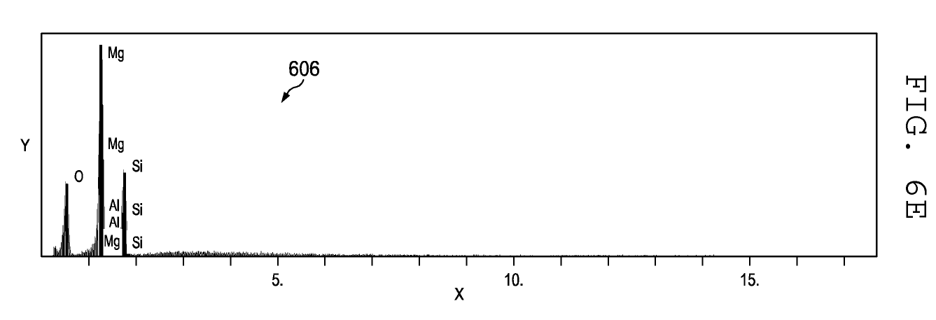

These materials were evaluated using the aforementioned refractory strip gradient test, which is a modified version of the test associated with ASTM C829-81 (2005) entitled “Standard Practices for Measurement of Liquidus Temperature of Glass by the Gradient Furnace Method”. Although the MgAl₂O₄ spinel (Frimax 7) that was tested is not isopipe grade material and would require significant engineering to make it suitable for an isopipe application, these tests, discussed below, still indicated the propensity for the formation of interface phases. The tests results are described next with respect to FIGS. 5 and 6A-6E.

FIG. 5 is a PLM image of the MgAl₂O₄ spinel (Frimax 7) refractory brick 502 and the alkali-containing glass 504 (TABLE #1) after conducting the refractory strip gradient test. As can be seen, the PLM image indicates a refractory interface 506 that is located between the MgAl₂O₄ spinel (Frimax 7) refractory brick 502, and the alkali-containing glass 504. In this test, the refractory interface 506 was identified as a secondary crystalline phase 506 referred to herein as Forsterite (magnesium silicate).

FIG. 6A is a PLM image of the MgAl₂O₄ spinel (Frimax 7) refractory brick 602 and the alkali-containing glass 604 (TABLE #2) after conducting the refractory strip gradient test. The PLM image indicates a refractory interface 606 that is located between the MgAl₂O₄ spinel (Frimax 7) refractory brick 602 and the alkali-containing glass 604. In this test, the refractory interface 606 was identified as a secondary crystalline phase 606, which was Forsterite (magnesium silicate). FIG. 6B is a SEM image (400×) of the MgAl₂O₄ spinel (Frimax 7) refractory brick 602, the alkali-containing glass 604, and the secondary crystalline phase 606 (Forsterite). FIGS. 6C and 6D show the EDX spectra identifying the elemental composition of the MgAl₂O₄ spinel (Frimax 7) refractory brick 602 and the alkali-containing glass 604 identified in the SEM image of FIG. 6B, respectively. FIG. 6E shows the EDX spectrum identifying the elemental composition of the secondary crystalline phase 606 (Forsterite) identified in the SEM image of FIG. 6B. The SEM/EDX analysis of the secondary crystalline phase 606 (Forsterite) indicated that this is a normal devit phase of the alkali-containing glass 604 and not a refractory interaction.

The microscopic analysis described above led to the use of a forming apparatus (isopipe) which is made from, or at least coated with, the chemically stable and compatible MgAl₂O₄ refractory material that can be used for forming an alkali-containing glass sheet. The MgAl₂O₄ refractory material can replace the zircon isopipe material, which is being dissociated by the action of alkali-containing glass. The MgAl₂O₄ refractory material is a naturally occurring isometric mineral comprised of oxides that are already used in the production of many alkali-containing glasses. Thus, the use of the MgAl₂O₄ refractory material avoids the use of non-compatible or compositionally different material with the alkali-containing glass. This is desirable since alkali-containing glass is used in many different products due at least in part to its ease of melting, cheap raw materials and abundant supply. Another advantage is that the raw materials needed to make the MgAl₂O₄ forming apparatus described herein are less expensive and more abundant than zircon.

The glass manufacturing system 200 that has been described herein uses the fusion process to form the alkali-containing glass sheet 204. The fusion process is described in detail within U.S. Pat. Nos. 3,338,696 and 3,682,609, the contents of which are incorporated herein by reference. In addition, while the glass manufacturing system 200 uses the specially configured MgAl₂O₄ isopipe 202 to fusion form the alkali-containing glass sheet 204, it should be understood that a differently configured MgAl₂O₄ forming apparatus could be incorporated within and used by different types of glass manufacturing systems to form alkali-containing glass sheets 204. For example, a specially configured MgAl₂O₄ forming apparatus can be used with a slot draw, re-draw, float, and other glass sheet forming processes that are either fully continuous or semi-continuous to produce discrete lengths of alkali-containing glass sheets 204. Lastly, it should be appreciated that the traditional glass manufacturing systems that use the zircon isopipe often make glass sheets that have very low concentrations of alkali metals and, as such, do not suffer from appreciable zircon dissociation. However, the glass sheets with very low alkali metal concentrations do have a defect called secondary zircon, in which the zircon dissolved from the isopipe at the upper hot portion precipitates as needles on the colder root ends. These needles break off and form zircon defects. These zircon defects are in no way similar to the zirconia defects caused by using a zircon isopipe to form an alkali-containing glass sheet.

Although one embodiment has been illustrated in the accompanying Drawings and described in the foregoing Detailed Description, it should be understood that the disclosure is not limited to the disclosed embodiment, but is capable of numerous rearrangements, modifications and substitutions without departing from the spirit of the disclosure, as set forth and defined by the following claims.

1. A glass manufacturing system comprising:
at least one vessel for providing an alkali-containing molten glass; and
a forming apparatus for receiving the alkali-containing molten glass from one of the at least one vessel and forming an alkali-containing glass sheet, wherein at least an exposed portion of the forming apparatus that contacts the alkali-containing molten glass comprises a magnesium aluminate spinel.

2. The glass manufacturing system of claim 1, wherein the at least one vessel includes a melting, fining, mixing or delivery vessel.

3. The glass manufacturing system of claim 1, wherein the forming apparatus includes a body having an inlet that receives the alkali-containing molten glass from the vessel, wherein the molten glass flows into a trough formed in the body and then overflows two top surfaces of the trough and runs down two sides of the body before fusing together where the two sides of the body come together to form the alkali-containing glass sheet, wherein the inlet, the trough, the two top surfaces, and the two sides of the body comprises the magnesium aluminate spinel.

4. The glass manufacturing system of claim 1, wherein the forming apparatus has a magnesium silicate secondary phase located at an interface between the exposed portion and the alkali-containing molten glass.

5. The glass manufacturing system of claim 1, wherein at least a portion of the forming apparatus is coated with the magnesium aluminate spinel.

6. The glass manufacturing system of claim 1, wherein the forming apparatus is made from the magnesium aluminate spinel.

7. The glass manufacturing system of claim 1, wherein the alkali-containing glass sheet has a composition of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

8. A method for manufacturing an alkali-containing glass sheet, the method comprising the steps of:
melting alkali-containing batch materials to form an alkali-containing molten glass; and
delivering the alkali-containing molten glass to a forming apparatus and forming the alkali-containing glass sheet, wherein at least an exposed portion of the forming apparatus that contacts the alkali-containing molten glass comprises a magnesium aluminate spinel.

9. The method of claim 8, wherein the forming apparatus includes a body having an inlet that receives the alkali-containing molten glass, wherein the molten glass which flows into a trough formed in the body and then overflows two top surfaces of the trough and runs down two sides of the body before fusing together to form the alkali-containing glass sheet, and wherein the inlet, the trough, the two top surfaces, and the two sides comprise the magnesium aluminate spinel.

10. The method of claim 8, wherein the forming apparatus has a magnesium silicate secondary phase located at an interface between the exposed portion and the alkali-containing molten glass.

11. The method of claim 8, wherein the forming apparatus is coated with the magnesium aluminate spinel.

12. The method of claim 8, wherein the forming apparatus is made from the magnesium aluminate spinel.

13. The method of claim 8, wherein the alkali-containing glass sheet has a composition of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 5 ppm Sb₂O₃; wherein 12 mol %≦Li₂O+Na₂O+K₂O≦20 mol % and 0 mol %≦MgO+CaO≦10 mol %.

14. A forming apparatus for forming an alkali-containing glass sheet, the apparatus comprising a body having an inlet that receives alkali-containing molten glass which flows into a trough formed in said body and then overflows two top surfaces ofthe trough and runs down two sides of the body before fusing together where the two sides of the body come together to form the alkali-containing glass sheet, wherein the inlet, the trough, the two top surfaces, and the two sides of the body comprise magnesium aluminate spinel.

15. The forming apparatus of claim 14, wherein the wherein the inlet, the trough, the two top surfaces, the two sides have a magnesium aluminate secondary phase located at an interface with the alkali-containing molten glass.

16. The forming apparatus of claim 14, wherein the alkali-containing glass sheet has a composition of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than ppm Sb₂O₃; wherein 12 mol %≦Li₂O+Na₂O+K₂O≦20 mol % and 0 mol %≦MgO+CaO≦10 mol %.
